(19) United States
(12) Patent Application Publication
(10) Pub. No.: US 2023/0206216 A1
(43) Pub. Date: Jun. 29, 2023

(54) BLOCKCHAIN BRIDGE SYSTEMS, METHODS, AND STORAGE MEDIA FOR TRADING NON- FUNGIBLE TOKEN

(71) Applicant: PANGEE, INC., New York, NY (US)

(72) Inventors: Laura LEHMANN, New York, NY (US); Sorat TUNGKASIRI, Skillman, NJ (US)

(21) Appl. No.: 17/666,788

(22) Filed: Feb. 8, 2022

Related U.S. Application Data
(60) Provisional application No. 63/293,407, filed on Dec. 23, 2021.

(51) Int. Cl. G06Q 20/36; H04L 9/32; G06F 21/10; G06Q 20/40; G06Q 40/04

(52) U.S. Cl. CPC G06Q 20/3672; H04L 9/3239; G06F 21/10; G06Q 20/401; G06Q 40/04; H04L 2209/38; G06F 2221/0713; G06Q 2220/00

(57) ABSTRACT

A method for trading a non-fungible token (NFT) among a plurality of blockchains includes minting an NFT based on digital content at a first blockchain, transferring the NFT to a second blockchain, trading the NFT between the second blockchain and a third blockchain, which is incompatible with the first blockchain, and recording the trade in the second blockchain.

### CROSS-REFERENCE TO RELATED APPLICATIONS

This application claims priority to, and benefit of, U.S. Provisional Patent Application No. 63/293,407 filed on Dec. 23, 2021, entitled “BLOCKCHAIN BRIDGE SYSTEMS, METHODS, AND STORAGE MEDIA FOR TRADING NON-FUNGIBLE TOKEN”, the entire content of which is incorporated by reference herein.

### FIELD

The present disclosure relates to blockchain bridge systems, methods, and storage media for trading a non-fungible token (NFT) and more particularly, for trading the NFT among incompatible blockchains.

### BACKGROUND

The art industry is a multi-billion dollar industry, which is made up of auction houses, such as Christie's and Sotheby's, art galleries, artists, and other third party actors. Over the last few years, there has been a gradual adoption of buying physical art online, which was once thought as inconceivable for high priced physical assets.

Initially, non-fungible tokens (NFTs) were generally related to crypto communities but later exploded into the art industry. The digital art NFT has not been considered as equal as its physical counterpart. However, physical art needs to be tied to a digital representation in the form of an NFT, as immersive computing and the metaverse become popular. Existing breakthroughs in light technology will enable projecting digital content at high resolutions and scales, all from a tiny chip. NFTs will soon live in the physical space through glasses, projectors and even holograms, irrespective of whether they are tied to a “physical” piece or not. The physical piece however will not exist in the metaverse if it is not tied to a digital representation and NFT.

Third-party NFT art marketplaces have proliferated in the last decade. Unfortunately, these NFT marketplaces, which are different from that of traditional galleries, generally cater to crypto friendly customers. Galleries generally cannot tap into their existing customers and website visitors on a third-party website, nor can they easily own relevant NFT data. Further, websites to display art owned by the gallery generally do not have an NFT minting platform. Furthermore, many galleries and artists are protective of their art and do not want it devalued by having it randomly placed on an e-commerce platform. Thus, galleries and artists have potentially lost a significant portion of their sales and future royalties when using a third-party marketplace to sell NFTs. For example, Beeple was minted as an NFT and sold at Christie's auction for $69 million in 2021.

Even if NFTs are minted in one blockchain, the NFT in one blockchain is incompatible with another blockchain. In other words, generally, the NFT in one blockchain is not directly transferrable to another blockchain. Thus, interoperability between two or more different blockchains can increase business scale and provide versatility of NFTs in the future.

### SUMMARY

The techniques of this disclosure generally relate to an NFT bridge platform across different blockchains, which are generally incompatible with each other. The NFT bridge platform provides capabilities of minting NFTs based on digital content included in websites, virtual reality (VR), augmented reality (AR), extended reality (XR), or metaverse via a plugin (e.g., widget) installed at a server or web browser and of selling and buying NFTs among incompatible blockchains. Further, this disclosure enables to consolidate NFTs across incompatible blockchains. Furthermore, this disclosure enables content owners to sell their NFTs at their respective websites.

According to aspects of the present disclosure, a method for trading a non-fungible token (NFT) among a plurality of blockchains includes minting an NFT based on digital content at a first blockchain, transferring the NFT to a second blockchain, trading the NFT between the second blockchain and a third blockchain, which is incompatible with the first blockchain, and recording the trade in the second blockchain.

In an aspect, the digital content is included or stored in a web server. The digital content is obtained by a widget integrated into the web server. The digital content is saved at a central server by the widget.

In another aspect, minting the NFT includes receiving selection of the digital content from an owner of the digital content.

In still another aspect, minting the NFT includes receiving content information of the digital content, and creating a first smart contract associated with the NFT. The first smart contract is written to the first blockchain.

In further aspects, the content information includes a title, description, date, artist information, digital content type, a rarity type, and royalty. The method includes uploading the NFT to a digital wallet. The second blockchain is an intermediary platform for trading the NFT between the first and third blockchains.

In still another aspect, transferring the NFT to the second blockchain includes creating a second smart contract based on the first smart contract, storing the first smart contract and the second smart contract to the second blockchain, and transferring ownership of the NFT to the second blockchain.

In further aspects, the transfer of the NFT and the first smart contract are written in the second blockchain. Trading the NFT includes receiving an order from a user of the third blockchain, receiving a payment via a cryptocurrency from the user based on the second smart contract; and transferring the NFT to the third blockchain.

In still yet another aspect, the payment via the cryptocurrency corresponds to a price included in the first smart contract.

According to aspects of the present disclosure, a blockchain bridge platform for a non-fungible token (NFT) among a plurality of blockchains includes a decentralized blockchain bridge server and a central server. The decentralized blockchain server includes a memory configured to store instructions a processor operatively coupled with the memory and configured to execute the instructions to mint an NFT based on digital content at a first blockchain, transfer the NFT to a second blockchain, trade the NFT between the second blockchain and a third blockchain, which is incompatible with the first blockchain, and record the trade in the second blockchain. The central server is configured to store trading information including transfer of the NFT and a smart contract related to the NFT.

In an aspect, the digital content is included or stored in a web server. The digital content is obtained by a widget integrated into the web server. The digital content is saved at the central server.

In another aspect, to mint the NFT, the processor executes the instructions further to receive selection of the digital content from an owner of the digital content.

In still another aspect, to mint the NFT, the processor executes the instructions further to receive content information of the digital content, and create a first smart contract associated with the digital content.

In further aspects, the first smart contract is written to the first blockchain. The content information includes a title, description, date, artist information, digital content type, a rarity type, and royalty. The first smart contract is upload to a digital wallet. The second blockchain is an intermediary platform for trading the NFT between the first and third blockchains.

In still another aspect, to transfer the NFT to the second blockchain, the processor executes the instructions further to create a second smart contract based on the first smart contract, store the first smart contract and the second smart contract to the second blockchain, and transfer the NFT to the second blockchain.

In further aspects, the transfer of the NFT and the first smart contract are written in the first blockchain. To trade the NFT, the processor executes the instructions further to receive an order from a user of the third blockchain, receive a payment via a cryptocurrency from the user based on the second smart contract, and transfer the NFT to the third blockchain.

In still another aspect, the payment via the cryptocurrency corresponds to a price included in the first smart contract.

In yet still another aspect, the central server is further configured to display the trading information including transfer of the NFT and the smart contract related to the NFT.

According to aspects of the present disclosure, a nontransitory computer-readable storage medium storing computer-executable instructions, when executed by a computer, cause the computer to perform a method for trading a non-fungible token (NFT) among a plurality of blockchains. The method includes minting an NFT based on digital content at a first blockchain, transferring the NFT to a second blockchain, trading the NFT between the second blockchain and a third blockchain, which is incompatible with the first blockchain, and recording the trade in the second blockchain.

The details of one or more aspects of the present disclosure are set forth in the accompanying drawings and the description below. Other features, objects, and advantages of the techniques described in this disclosure will be apparent from the description and drawings, and from the claims.

### BRIEF DESCRIPTION OF THE DRAWINGS

Various aspects of the present disclosure are described herein with reference to the drawings, wherein:

FIG. 1 is a block diagram for a blockchain bridge system for trading a non-fungible token (NFT) between blockchains according to aspects of the present disclosure;

FIG. 2 is a block diagram for a blockchain bridge system for a distributed ledger according to aspects of the present disclosure;

FIG. 3 is a block diagram illustrating generation of a new block to a distributed ledger according to aspects of the present disclosure;

FIG. 4 is a block diagram illustrating interaction between the central server and the blockchain of the blockchain bridge system of FIG. 1 and a web server according to aspects of the present disclosure;

FIG. 5 is a flowchart illustrating a method for minting NFTs according to aspects of the present disclosure;

FIG. 6 is a flowchart illustrating a method for minting NFTs via a plugin according to aspects of the present disclosure;

FIG. 7A is a flowchart illustrating a method for transferring NFTs from a blockchain to an intermediary blockchain according to aspects of the present disclosure;

FIG. 7B is a flowchart illustrating a method for transferring NFTs from an intermediary blockchain to another blockchain according to aspects of the present disclosure; and

FIG. 8 is a block diagram of a computing device according to aspects of the present disclosure.

### DETAILED DESCRIPTION

Aspects of the presently disclosed blockchain bridge systems and methods for minting a non-fungible token (NFT) and trading the NFT among incompatible blockchains are described in detail with reference to the drawings. The blockchain bridge systems and methods of the present disclosure are capable of minting digital content from a web server singly or in bulk and trading NFTs among incompatible blockchains.

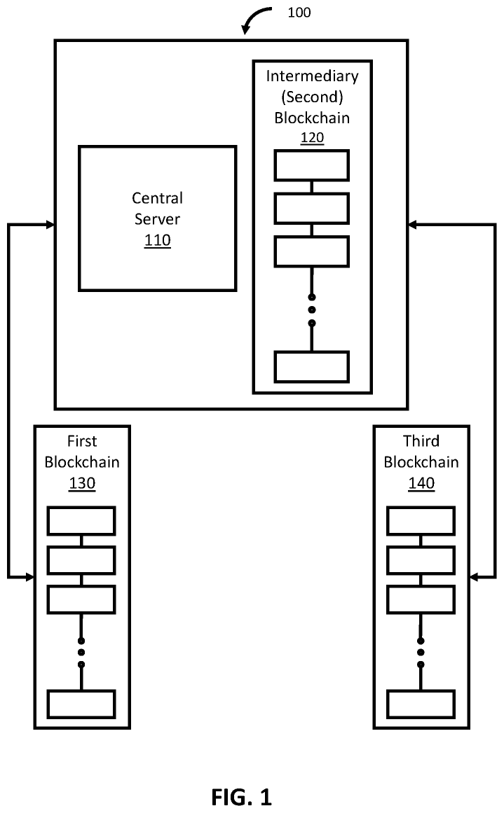

Referring to FIG. 1, a blockchain bridge system 100 is disclosed. The blockchain bridge system 100 includes a central server 110 and an intermediary (second) blockchain 120. The central server 110 may store transactions between a first blockchain 130 and a third blockchain 140, which is different from or incompatible with the first blockchain 130. The first blockchain 130 and the third blockchain 140 may represent any blockchain systems, such as Ethereum, Binance, Tezos, Steller, Hyperledger Fabric, EOS, Corda, Tron, Hedera Haspraph, Solana, etc., which support NFTs. The central server 110 may include any digital content obtained from a web server, virtual reality (VR), augmented reality (AR), extended reality (XR), or metaverse.

A blockchain is a distributed digital ledger or, in short, a distributed ledger containing hash codes of transactions that are stored on a distributed network of computing devices. A distributed ledger is a record of immutable transactions which are contained in each block. Every transaction contains cryptographic hashes and timestamps thereof. When a block of records is filled or a period for generating a block has passed, that block of records is written as a new block, which becomes the recent or current block in the distributed ledger. By generating a new block based on its predecessor or previous block, all blocks are connected to each other. That is why the distributed ledger is called a blockchain. Since blockchains are publicly distributed, they are managed by a complex series of networks. Each node on the network adheres to a protocol in order to validate new blocks onto the blockchain. Most blockchains use a byzantine fault tolerance system to ensure that false records cannot be placed into the system.

All blockchains are implemented in a form of a closed loop system, meaning that blockchains do not communicate with each other and do not share information. Even though blockchain ecosystems have been developed to increase interoperability among blockchains, currently, each blockchain is still a standalone system or closed loop system. Further, one blockchain cannot write a block to a distributed ledger in another blockchain. For example, the first blockchain 130 may be Solana and the third blockchain 140 may be Ethereum. Since Binance blockchain and Ethereum blockchain are incompatible to each other, any direct transaction between them is impossible at this time. Thus, the second blockchain 120, as an intermediary, is provided to enable smooth transactions of NFTs between Solana and Ethereum blockchains or any other incompatible blockchains.

Additional to the closed loop system, each blockchain uses different technology to solve specific problems for their respective blockchain to add a new block. These are called protocols that are rules and procedures that govern sharing of data between two or more computing devices, which are called nodes. The nodes connect through the internet in a distributed manner. Each of these distributed nodes stores the same chain of blocks. Thus, this chain of blocks stored in the distributed nodes is called a distributed ledger.

Each blockchain network may be implemented in different languages to help the blockchain achieve its goals. The main languages used for blockchain development are C, C++, Java, C #, Javascript, Go, Python, Ruby, and Solidity. This list is not meant to limit the scope of this disclosure but are provided as example. There are at least a dozen more languages used for implementing blockchain technology. The most popular languages are C++, Java, Python, C #, and Go. Combination of programing languages may simplify use or speed up development. Due to different base programming language, it is further difficult for blockchains to communicate with each other.

The intermediary blockchain 120, the first blockchain 130, or the third blockchain 140 stores a distributed ledger, which has a chain of blocks, in a respective storage medium. The intermediary blockchain 120, the first blockchain 130, and the third blockchain 140 are illustrated as a single computing device but represent all other nodes, which save the same respective distributed ledgers. By saving the same distributed ledger in many nodes or computing devices, the distributed ledger is protected from hampering, hacking, or cracking. Generally, when a majority of the nodes, which save the same distributed ledger, agree with creation of a block, that block can be verified and saved as a new block in the distributed ledger or the blockchain. Thus, unless a hacker or cracker has a sufficient computing power to manipulate a majority of the nodes to provide an approval for a next block, the next block cannot be created/saved in the distributed ledger.

Each block includes information including, for example, one or more transactions of cryptocurrency, non-fungible tokens (NFTs), smart contracts, etc. Each block is connected to its previous block and successive block. For example, a successive block is generated based on its previous block. Specifically, every block includes its signature information, such as a hash value. Since the hash value of a current block is generated based on the hash value of its previous block and the information of the current block. In this way, every block is directly or indirectly connected back to the first block or the genesis block. The hash value is an example of connecting information between blocks and the connecting information may include other types of information without departing from this disclosure.

Smart contracts are employed in trading fungible tokens and/or NFTs or assigning responsibilities among two or more parties. A smart contract is a computer program or a transaction protocol which automatically executes an action or a series of actions when a predefined condition is met. Smart contracts are used to automate execution of an agreement without intervention by a third party. It is designed to enforce the terms of the agreement, such as exchange of cryptocurrencies, tokenized rights, proof of identity, transfer of ownership on the premise of payment, or any other types of agreements. As such, a smart contract includes a program, software, or code that is executed deterministically in the context of a blockchain network, and includes sets of conditions as in if-statements and actions to be automatically executed as in then-statements when the conditions are met. That automated execution is also written onto the blockchain once the execution is completed. Smart contracts may store small amounts of data in common data structures, which identify and track an owner of crypto tokens or NFTs. Since there is no third-party intervention, mistakes are mitigated, and all records are encrypted and shared in the blockchain.

In an aspect, a single smart contract may be used in creation of one or more NFTs or fungible tokens according to token standard (e.g., ERC1155 standard or further developed standard).

An NFT is a unique and non-interchangeable unit of data stored on a distributed ledger. NFTs are generally associated with digital content, which is easily-reproducible digital objects, such as photos, videos, audio, and other types of digital files as unique items, and of which a public proof of ownership is provided by characteristics of blockchains. In other words, the digital file of the digital content can be easily copied by users, other than the owner, but the owner of the digital file cannot be easily changed without transfer of the ownership by the current owner. Further, the original owner or the creator of the digital file of the digital content still has its corresponding copyright, meaning that royalty may have to be paid when the digital file is transferred, sold, re-sold, copied, modified, or used based on terms in its smart contract.

In an aspect, NFTs may be for digital assets, such as game items (e.g., clothing (shirts, socks, pants, gloves, and armors) for a game player, a weapons pack (e.g., a gun, shield, and bullets, etc.) which game players can purchase and use during the game, digital artwork (e.g., paintings, building designs, etc. in a metaverse) or any combination thereof.

As described above, most of blockchains are not compatible to each other. To resolve the incompatibility, the intermediary blockchain 120 plays a role to mediate between the first blockchain 130 and the third blockchain 140. Specifically, when a first or original NFT is minted in the first blockchain 130, the minted first NFT is transferred to the intermediary blockchain 120 together with the original or first smart contract associated with the minted first NFT. Such transfer is recorded both in the first blockchain 130 and the intermediary blockchain 120. Further, the central server 110 also saves the transfer and the first smart contract.

After the transfer of the first NFT from the first blockchain 130 to the intermediary blockchain 120, the first NFT, which was saved in the first blockchain 130, is removed or deactivated from the first blockchain 130, the digital content associated with the first NFT is transferred to the central server 110, and the first smart contract associated with the first NFT is also transferred to the central server 110. A second NFT is minted in the intermediary blockchain 120 by retrieving the digital content from the central server 110. In this way, the second NFT associated with the digital content is saved in the intermediary blockchain 120. A second smart contract may be generated based on the information extracted from the first smart contract saved in the central server 110.

In various aspects, a third smart contract may be generated when a user in the third blockchain 140 wants to buy the new NFT. Since the value of the cryptocurrency related to the intermediary blockchain 120 is different from the value of the cryptocurrency used in the third blockchain 140, the third smart contract may set the price of the second NFT in consideration of the value ratio between the cryptocurrency in the first blockchain 130 and the cryptocurrency in the third blockchain 140 based on the price set by the owner of the original NFT in the first blockchain 130.

When the user pays the price of the second NFT with the cryptocurrency in the third blockchain 140, the third smart contract is executed, thereby the second NFT is transferred from the intermediary blockchain 120 to the third blockchain 140. The sale of the second NFT is saved in the central server 110 to easily keep track of the ownership of the digital content. In an aspect, the central server 110 may save links to all transactions, and users can access respective blockchain through the links and clearly view the transactions. In another aspect, the central server 110 may provide a web portal to display all the information of every transaction for transparency and ease of traceability.

Further, the sale of the second NFT is also saved in a block of the intermediary blockchain 120. Specifically, the digital content associated with the intermediary blockchain 120 is transferred to the third blockchain 140, a third NFT is minted based on the digital content in the third blockchain 140. A third smart contract is also generated to mimic the second smart contract according to the cryptocurrency in the third blockchain 140.

In various aspects, the first, second, and third smart contracts may include common information, such as the digital content, the creator of the digital content, royalty, rarity, etc. With these features, the blockchain bridge system 100 can streamline transactions of NFTs between two different, incompatible blockchains.

In various aspects, NFTs may be used to authenticate physical products, for example, luxury goods such as a Chanel® bag. Thus, physical product NFTs may be transferred along blockchains according to transfer of ownership of the corresponding physical products. In another case, NFTs may be only for digital assets separate from the corresponding physical product. For example, an NFT of a digital version of Chanel® bag, which is as same as or different from a corresponding physical bag, may be minted so that an avatar or a digital person can use in a digital world (e.g., metaverse, games, etc.).

In various aspects, the intermediary blockchain 120 may create its own crypto tokens to maintain stability and constancy of value within the intermediary blockchain 120. The crypto tokens may be used as a buffer between first cryptocurrency used in the first blockchain 130 and second cryptocurrency used in the third blockchain 140 so that payment of the second cryptocurrency may be smoothly transferred to a digital wallet in the first cryptocurrency of the content owner via the crypto tokens.

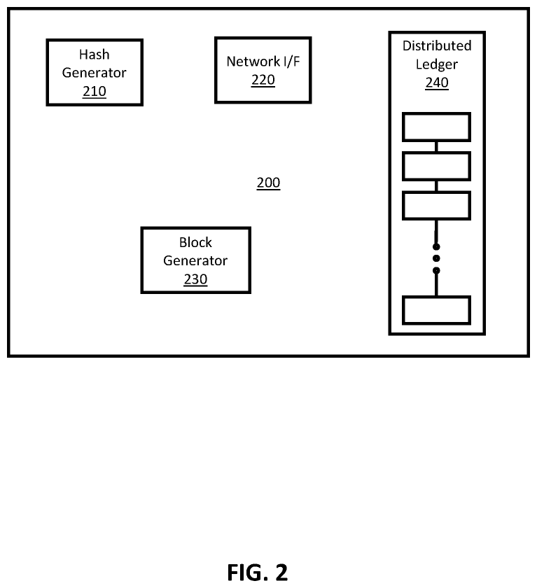

FIG. 2 is a block diagram of a server 200, which stores a distributed ledger 240 in accordance with aspects of the present disclosure. The server 200 may include a hash generator 210, a network interface 220, a block generator 230, and a distributed ledger 240. The hash generator 210 may include a hash function to generate a hash code upon generation of a new block. The hash value may be an alphanumeric sequence, a hexadecimal sequence, or any other sequence of a combination thereof. Advantages of using hash functions are that the hash function outputs a series totally different from a series generated from first data when second data is slightly different from the first data. For example, when the first data is “Sarah” and the second data is “Sara”, the hash code generated from the first data is totally different from the hash code generated from the second data. Thus, usage of hash codes further increases a level of security.

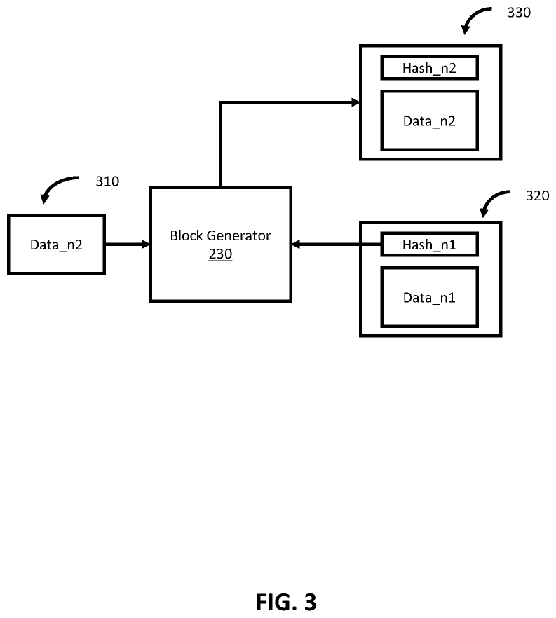

The block generator 230 generates a block to be saved in the distributed ledger 240. Each block is closely related to its previous block. For example, FIG. 3 illustrates how blocks are closely related to each other, in particular, to its preceding block. When current transactions 310, Data_n2, come, the block generator 230 retrieves a hash code, Hash_n1, from its previous block 320.

The block generator 230 uses the current transactions 310, Data_n2, and the previous hash code, Hash_n1, as input to the hash function executed by the hash generator 210. The hash function then generates a current hash code, Hash_n2, and the block generator 230 then generates the current block 330 by combining the current hash code, Hash_n2, and the current transactions 310, Data_n2. Since the current block 330 is partly generated from the hash code of the previous block 320, every block is closely related to its previous block. Thus, modifying the data content of one block is not feasible unless hash codes of all blocks starting from the genesis block are correspondingly modified.

Now referring back to FIG. 2, when the current block is generated, the generated block is saved in the distributed ledger 240. Since the blockchain technology is used in the distributed ledger 240, the distributed ledger 240 is practically safe from potential modification of data saved in the distributed ledger 240. Since the same distributed ledger 240 is saved in all the nodes, it is almost impossible to modify any data saved in the distributed ledger 240 unless data and hash codes of all blocks saved in all the nodes are modified at almost the same time. The reasons behind almost the same time modification are that a majority of the nodes validate each block before saving it in the distributed ledger 240. If attempts are made to modify transactions in the distributed ledger 240 saved in a minority group of the nodes, such attempts cannot pass the validation process and the distributed ledger 240 cannot be modified.

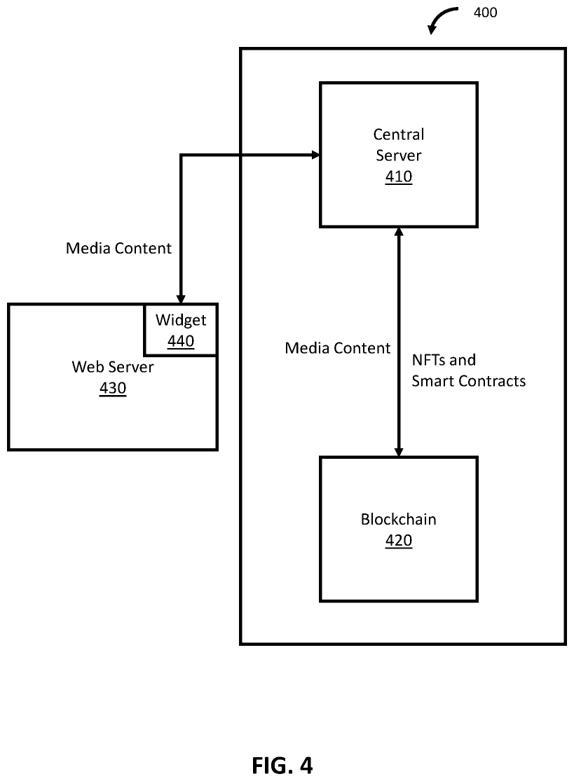

Referring now to FIG. 4, a block diagram of a system 400 for minting an NFT based on digital content saved in a web server 430 is illustrated according to aspects of the present disclosure. A content owner generally saves digital content (e.g., texts, photos, audios, videos, or layouts of combination thereof, etc.) at a web server 430. In aspects, the web server 430 may be a website hosting server and store digital content for websites.

In various aspects, the web server 430 may be a server providing AR, VR, XR, or metaverse (hereinafter collectively the “metaverse”) and store digital content for the metaverse. Since the metaverse is predominantly visual, the web server 430 may display contextual information around an image. When users select an image, the web server 430 may display description of the image around the image. For example, a photo of David's sculpture by Michelangelo may be in an image database, and automatically displayed when a user is walking through the Galleria dell's Academia in Florence in the metaverse. Although the user has not selected the image of David's sculpture, its contextual information may be displayed when the user is looking at the image of David's sculpture. For simplicity purposes, the digital content or contents described below also refer digital content from the metaverse and the web server also refers to metaverse server.

In a case when the content owner wants to create NFTs based on the digital content, it is impractical for the content owner to manually search for digital content saved on the website or metaverse and mint an NFT for each digital content. For example, an owner of an art gallery owns and operates a website showing digital art or digital counterparts of the art displayed at the art gallery. The digital counterparts are saved at webpages in various levels according to respective categories of the art on the website. Further, a painting may be saved in several webpages based on categorization of the painting. Thus, due to the volume of the digital art, the art gallery owner may not be able to manually mint each of the digital art. Nevertheless, the content owner may choose to manually search for digital content to be minted and manually upload the selected digital content to the central server 410.

To streamline minting processing, a widget 440 is installed in the web server 430. When the widget 440 is initiated by the content owner, the widget 440 automatically crawls each webpage on the website, retrieves the digital content saved in the web server 430, and transmits the retrieved digital content to a central server 410. In an aspect, the widget 440 may grab contextual information of the digital content located around the digital content and transmit the digital content and its respective contextual information to the central server 410. The contextual information includes description, title, price, or relevant information of the digital content and may be used to automatically provide necessary information when minting an NFT of the digital content.

In aspects, the widget 440 may be integrated within a web browser of the content owner. When the content owner initiates the widgets at the website, the widget 440 may scan through the internal memory storing representation of the webpage by traversing webpage structure, which includes links, metadata, and digital content. The widget 440 extracts the links, metadata, and the digital content to associate the metadata with the digital content. The metadata may include the information (e.g., title, description, creator, data of production, etc.) about the digital content and retrieve digital content from a remote server, which saves the digital content, via the links.

The central server 410 may be a server isolated from other servers and which can locally save the received data. The content owner may log in to the central server 410 with login credential information to access the saved digital content, which are owned by the content owner and transmitted from the web server 430 by the widget 440. The content owner reviews the saved digital content and selects part or all of the saved digital content for generating NFTs. During selection of digital content, portions of the information can be automatically obtained from the contextual information saved with the digital content in the central server 410 and the other portions are manually input by the content owner. In an aspect, the information may include information of the content owner, title, description, price, rarity type, and royalty type. This list is exemplary and can include other information readily appreciated by persons having ordinary skill in the art.

The central server 410 may provide the selected digital content and its related information to a blockchain 420 to mint NFTs based on the selected digital content. When the NFT is minted in the blockchain 420, the NFT and its smart contract are saved in a block in a distributed ledger, which is a chain of blocks saved in the blockchain 420. In an aspect, the blockchain 420 may provide information related to the NFT and the smart contract back to the central server 410 so that the central server 410 is able to keep track of NFTs (e.g., owners of the digital content saved in the central server 410).

In various aspects, the central server 410 may provide bulk mining functionality. When the widget 440 retrieves digital content and the central server 410 saves digital files with corresponding contextual information. When the content owner logs in after successful multiple authentications, the central server 410 may provide a list of digital files of the digital content so that the content owner is able to select multiple digital files for minting. When the content owner clicks a mint button (which is not shown) with selection of multiple digital files, the central server 410 automatically mints a NFT for each of the selected digital files based on the content information.

In various aspects, a single smart contract may be used for minting multiple NFTs. Further, the single smart contract may be used in creating fungible tokens and multiple NFTs. Furthermore, since different types of fungible tokens or NFTs can be minted with a single smart contract, interoperability between different or incompatible blockchains can be increased.

In various aspects, the central server 410 provides a user interface such that the content owner is able to list a part or all of the minted NFTs for sale, remove NFTs from the sale, and manage the minted NFTs. Further, the central server 410 may provide payment methods so that the content owner pays for the minting process and manages funds from sales via check, wire transfer, credit card, and/or cryptocurrency.

In various aspects, when a user visits the website after completion of the minting process, the widget 440 may display an overlay window over the website and display NFTs, which have been selected by the content owner for sale, in the overlay window. The user is then able to select and purchase a NFT at the website via the widget 440 without departing from the website. The widget 440 may also provide various payment means via check, wire transfer, credit card, and/or cryptocurrency. Through and via the widget 440, the content owner can mint NFTs individually or in bulk based on digital content saved at the website and users of the website can purchase the NFTs at the website without leaving it with several payment methods.

In further various aspects, since the central server 410 keeps track of NFTs, which have been minted through the central server 410, every new webpage, which posts the digital content, can be also tracked by the central server 410. For example, an NFT digital representation of David's sculpture may be in one's living room in the metaverse. Contextual information about the sculpture may be displayed in response to voice command such as “tell me more about this sculpture” in the metaverse or by user's look at. This contextual information may be as simple as the sculpture's date and artist, or as long as an article associated with the sculpture. The metaverse version of David's statue is tied back to the other images of David (via metadata architecture) and have access to the other images' contextual data. In this regard, the central server 410 keeps tracks of NFTs, digital content, and corresponding contextual information, and is capable of tracking of other digital content which is tied to the image based on the contextual information.

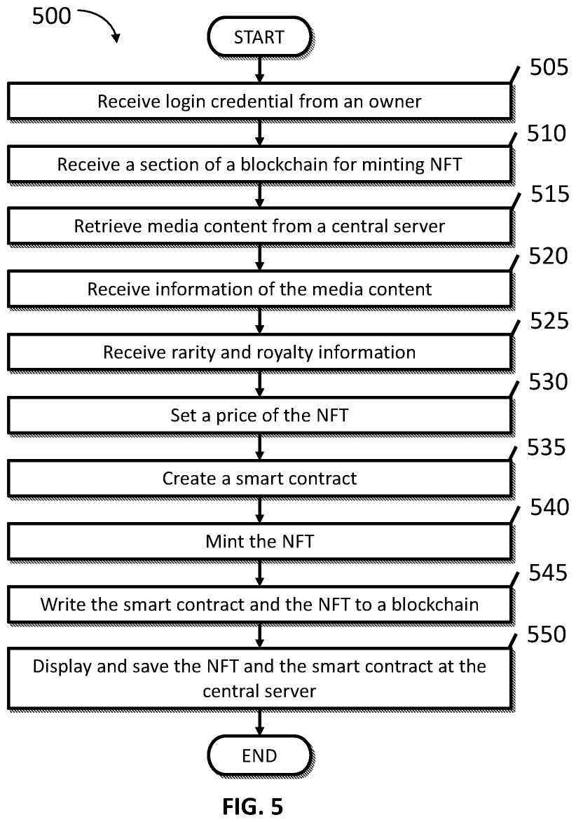

Referring now to FIG. 5, a method 500 for minting an NFT based on digital content on a blockchain bridge system is illustrated according to aspects of the present disclosure. The blockchain bridge system may include a central server and a blockchain as shown in FIG. 1. A owner of digital content needs login to the central server to mint an NFT. Thus, the method 500 starts by receiving login credentials from the owner at step 505. When the owner is new to the central server, the owner has to go through a verification process via email and dual authentication to set login ID and password. After registering the login credentials, the owner also needs to create a digital wallet at the central server or connect the owner's digital wallet to the central server.

After successful login to the central server, the owner selects a blockchain to mint an NFT. For this purpose, the central server may provide a list of blockchains to the owner because not every blockchain supports minting NFTs. At step 510, the selection of the blockchain is received by the central server.

At step 515, the central server receives digital content from the owner. In a case when the digital content is stored at the central server, the owner's selection is provided to the central server. In another case when the digital content is not stored at the central server, the owner uploads the digital content to the central server. As described above, the digital content may be digital text, photo, audio, video, combination thereof, and any layouts thereof. In an aspect, the digital content may be retrieved from a webpage or the metaverse.

At step 520, information related to the digital content is received by the central server. The related information may include title, description, art date, artist information, etc., which are pertinent for minting an NFT. The related information may include a precise location in the metaverse so that the location of an image of the digital content can be identified in the metaverse. This list of the relevant information is not limited thereto and may include other information associated with the digital content.

Rarity information is then received by the central server at step 525. The rarity information can be 1 of 1, 1 of 10, 1 of 100, etc., indicating how rare the NFT is compared to other NFTs. When 1 of 100 is selected as the rarity information, the NFT to be minted is identified as being rare as 1 out of 100 NFTs. In an aspect, the central server may provide a list of rarity information and the owner selects one in the list. The selected rarity information may affect the price of the NFT to be minted.

Also at step 525, royalty information is received by the central server and a smart contract is generated. The royalty information dictates how much is to be paid to the creator of the NFT when the NFT is sold or re-sold. For example, when the royalty is set as 20% and the NFT is sold or re-sold, 20% of the price will be paid to the creator of the NFT and the rest is paid to the owner of the NFT at the time of sale automatically executed by the smart contract. In an aspect, the royalty may be set for copying, using, modifying the digital content.

At step 530, the price of NFT is set by the owner. The price may be in U.S. dollars, other fiat currency, or cryptocurrency associated with the selected blockchain.

In an aspect, the owner may have a chance to review, revise, and update the information before minting the NFT.

At step 535, based on the received information from the owner, a smart contract is created. For example, the smart contract includes the royalty information so that royalty is paid to the original owner or creator of the NFT when sale of the NFT occurs and the rest of the price is paid to the current owner of the NFT. Further, according to the purchase and the terms in the smart contract, ownership of the NFT is transferred to the purchaser.

The NFT is minted based on the digital content at step 540. The owner may be asked whether to transfer the NFT to the owner's digital wallet or digital wallet at the central server. Further, the owner may be asked to pay for the minting.

After completion of the minting, the smart contract and the NFT is recorded on a block, which is to be written in the distributed ledger, at step 545. Further, the central server may locally save the smart contract and a link to the NFT so that the owner can access the state of the NFT. The central server may display NFTs, which the owner has minted, in a dashboard. In an aspect, the displayed NFTs may have links to respective blockchains. So, when the owner selects and clicks one of the displayed NFTs, the owner is led to the blockchain of the selected NFT.

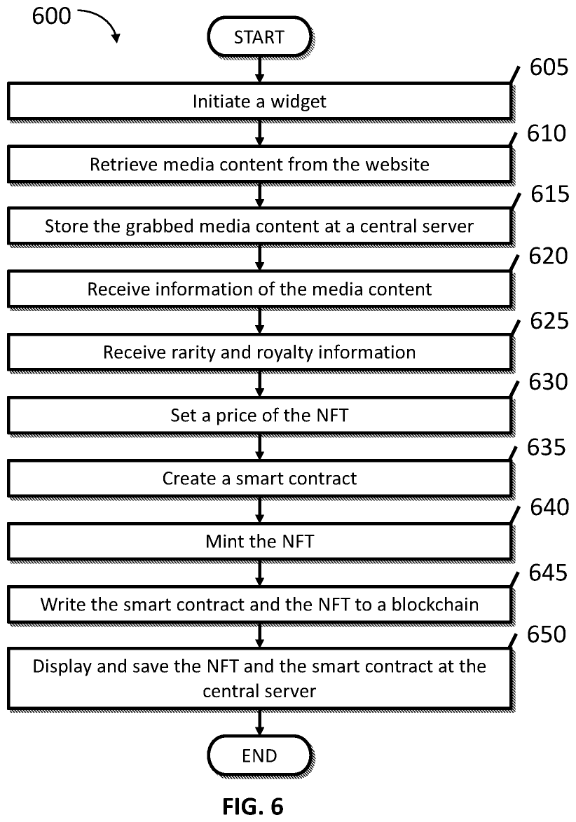

FIG. 6 illustrates another method 600 for minting an NFT via a plugin according to aspects of the present disclosure. Through the plugin, the method 600 may enable a user to automate minting an NFT. The plugin is installed at a web server or a web browser. The plugin may be a widget. The method 600 is started by initiating the widget at step 605.

At step 610, the widget crawls a web page when an owner accesses the web page serviced by the web server and initiates the widget, and retrieves digital content in the web page. In a case when the web server is a metaverse server, the widget retrieves digital content, which is owned by the user, in the metaverse. The digital content may include digital text, photo, audio, video, combination thereof, and any layouts thereof.

The widget transmits the retrieved digital content to a central server of a blockchain bridge system. The transmitted digital content is saved locally at the central server at step 615.

At step 620, the widget further retrieves information related to the digital content. The information may be pertinent to minting NFTs based on the digital content. For example, the information may include title, description, artist information, etc. The widget may extract the related information from metadata and description of the digital content.

Steps 625-650 are similar to steps 525-550 of the method 500. Thus, the description of steps 625-650 can be found above with respect to steps 525-550.

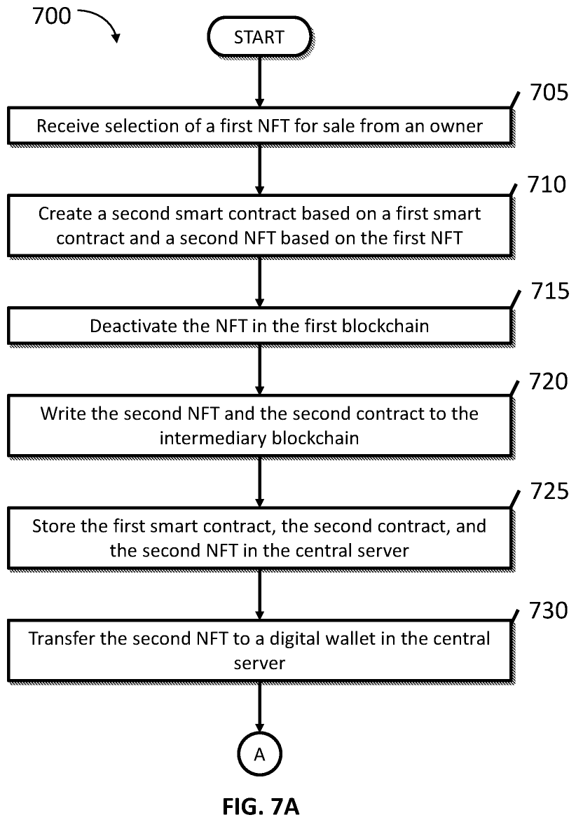

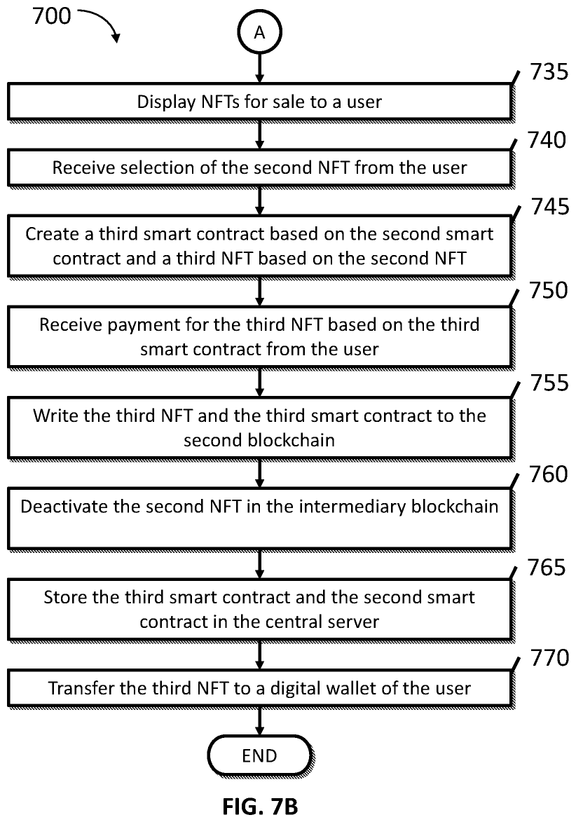

Now referring to FIGS. 7A and 7B, a method 700 for transferring NFTs from a blockchain to another blockchain is illustrated according to aspects of the present disclosure. When the NFT is to be sold from a first blockchain to a second blockchain, which is incompatible with the first blockchain, the method 700 can be applied to complete the sale between the incompatible blockchains. FIG. 7A illustrates how the NFT is transferred from the first blockchain to an intermediary blockchain, and FIG. 7B illustrates how the NFT is transferred from the intermediary blockchain to the second blockchain.

When NFTs are to be on sale, the owner selects a first NFT for sale. The owner's selection is received by a central server of a blockchain bridge system at step 705. The digital content, related information, and the first (or original) smart contract associated with the first NFT are transferred to the central server of the blockchain bridge system.

At step 710, based on the digital content and the related information, a second NFT is created in the intermediary blockchain. Further, based on the first smart contract, a second smart contract is created. Upon creation of the second NFT, the first NFT is deactivated in the first blockchain at step 715. In an aspect, the first NFT may be deleted from the first blockchain at step 715.

At step 720, the second smart contract and the second NFT are written/recorded in a block of a distributed ledger stored in the intermediary blockchain. As described above, the second smart contract and the second NFT may be saved in the block with other transactions. In an aspect, the block of the second NFT may include a link to a block of the first blockchain where the first NFT is stored.

The second smart contract and the second NFT are also saved in the central server at step 725. Further, the first smart contract is also saved in the central server. In case when the owner cancels his intention to sell the first NFT, the central server may transmit the first smart contract and the digital content to the first blockchain and reactive the first NFT. In this case, the second smart contract and the second NFT are removed from the intermediary blockchain and from the central server.

At step 730, the second NFT is transferred to a digital wallet internal to the central server. This completes the first half of the method 700.

Now the second NFT is listed for sale. When a purchaser of a second blockchain visits the web page or metaverse, the purchaser may be able to see NFTs for sale via a widget installed at the web server or the purchaser's web browser at step 735. In particular, the widget accesses the central server for the sale information of NFTs and overlays a window over the web page or the metaverse to display NFTs available for sale.

The purchaser may can select NFTs from the displayed NFTs for purchase. At step 740, the widget receives the purchaser's selection of the second NFT for purchase, and at step 745, the third smart contract is created based on the second smart contract, and the third NFT is created based on the information related to the second NFT. By keeping the content or information of the original smart contract or the first smart contract in the second and third smart contracts, trades between incompatible blockchains can be made and interoperability between blockchains can be increased. Further, trading multiple NFTs can be made with a single smart contract, thereby reducing necessary gas fees for the transactions.

At step 750, the widget receives payment for the third NFT from the purchaser based on the price set forth in the third smart contract. In case when the price of the first NFT is in U.S. dollar (USD), the second and third smart contracts also set the price in USD and the purchaser pays the price in USD via credit card or wire transfer. In case when the price is in cryptocurrency associated with the first blockchain, the third smart contract also sets the price in cryptocurrency associated with the second blockchain based on the swap ratio of the cryptocurrencies between the first and second blockchains. To streamline the payment process, the widget may be able to provide a shopping cart and various payment methods.

In various aspects, to streamline the purchase via cryptocurrency, the blockchain bridge system may mint a cryptocurrency associated with the intermediary blockchain. In this case, the second smart contract may set the price in terms of the cryptocurrency associated with the intermediary blockchain based on the swap ratio of the cryptocurrencies between the intermediary blockchain and the first blockchain, and the third smart contract may set the price in terms of the cryptocurrency associated with the cryptocurrency of the second blockchain based on the swap ratio of the cryptocurrencies between the intermediary blockchain and the second blockchain.

After reception of the payment, the third smart contract and the third NFT are saved in a block to be connected to the second blockchain at step 755, and the second NFT in the intermediary blockchain is deactivated at step 760. In an aspect, when the payment is not made within a predetermined period, the third smart contract and the third NFT are removed from the second blockchain and the second NFT is reactivated in the intermediary blockchain.

At step 765, the central server locally stores the third smart contract and the second smart contract. Further, the central server and the intermediary blockchain also save links to the blocks of the intermediary and second blockchains. In this way, the owner of the first NFT is able to track the first, second, and third NFTs via the central server.

By transferring the third NFT to a digital wallet of the purchaser in step 770, the sale of the NFT between incompatible blockchains is completed.

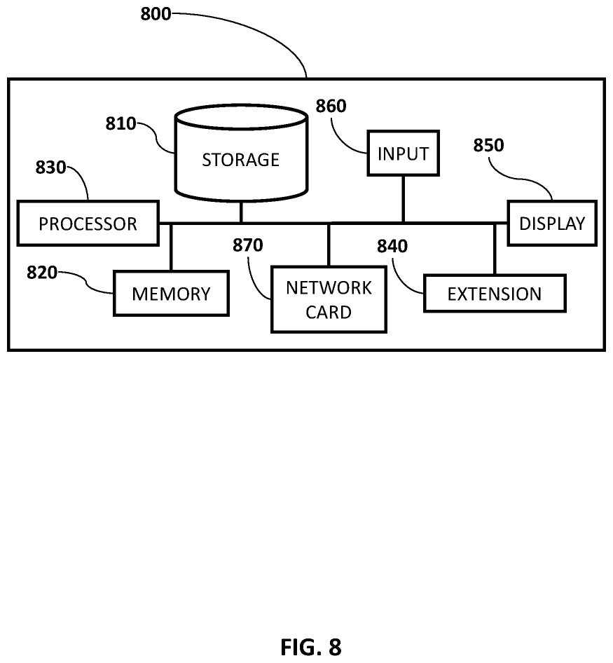

FIG. 8 is a block diagram for a computing device 800, which is configured to perform operations, tasks, or features of computers/servers/mobile devices (e.g., the central server 110, blockchain servers 120-140, the web server 430, and any computing/mobile devices) disclosed above in this disclosure. The computing device 800 may be connected to one or more external devices and control to perform steps of the methods 500-700 of FIGS. 5-7B. The computing device 800 may include, by way of non-limiting examples, server computers, desktop computers, laptop computers, notebook computers, sub-notebook computers, netbook computers, netpad computers, set-top computers, handheld computers, Internet appliances, mobile smartphones, tablet computers, personal digital assistants, embedded computers, wearable computing devices (e.g., AR/VR devices, Google Glass, smart watches, etc.), cloud servers, and any other devices capable of performing calculations. Those of skill in the art will recognize that many mobile or smart phones are suitable for use in the system described herein. Suitable tablet computers include those with booklet, slate, and convertible configurations, known to those of skill in the art.

In various aspects, the computing device 800 includes an operating system configured to perform executable instructions. The operating system is, for example, software, including programs and data, which manages the device's hardware and provides services for execution of applications. Those of skill in the art will recognize that suitable server operating systems include, by way of non-limiting examples, FreeBSD, OpenBSD, NetBSD®, Linux, Apple® Mac OS X Server®, Oracle® Solaris®, Windows Server®, and Novell® NetWare®. Those of skill in the art will recognize that suitable personal computer operating systems include, by way of non-limiting examples, Microsoft® Windows®, Apple® Mac OS X®, UNIX®, and UNIX-like operating systems such as GNU/Linux®. In various aspects, the operating system is provided by cloud computing. Those of skill in the art will also recognize that suitable mobile smart phone operating systems include, by way of non-limiting examples, Nokia® Symbian® OS, Apple® iOS®, Research In Motion® BlackBerry OS®, Google® Android®, Microsoft® Windows Phone® OS, Microsoft® Windows Mobile® OS, Linux®, and Palm® WebOS®.

In various aspects, the computing device 800 may include a storage 810. The storage 810 is one or more physical apparatus used to store data (e.g., distributed ledgers, smart contracts, blocks in the distributed ledger) or programs (e.g., hashing functions, minting module, etc.) on a temporary or permanent basis. In various aspects, the storage 810 may be volatile memory and requires power to maintain stored information. In various aspects, the storage 810 may be non-volatile memory and retains stored information when the computing device 800 is not powered. In various aspects, the non-volatile memory includes flash memory. In various aspects, the non-volatile memory includes dynamic random-access memory (DRAM). In various aspects, the non-volatile memory includes ferroelectric random-access memory (FRAM). In various aspects, the non-volatile memory includes phase-change random access memory (PRAM). In various aspects, the storage 810 includes, by way of non-limiting examples, CD-ROMs, DVDs, flash memory devices, magnetic disk drives, magnetic tapes drives, optical disk drives, solid state drives, and cloud computing-based storage. In various aspects, the storage 810 may be a combination of devices such as those disclosed herein.

The computing device 800 further includes a processor 830, an extension 840, a display 850, an input device 860, and a network card 870. The processor 830 is considered as a brain to the computing device 800. The processor 830 executes instructions which implement tasks or functions of programs. When a user executes a program or the program is automatically executed based on a batch process, the processor 830 reads the program stored in the storage 810, loads the program on the RAM, and executes instructions prescribed by the program.

The processor 830 may include a microprocessor, central processing unit (CPU), application specific integrated circuit (ASIC), arithmetic coprocessor, graphic processor, or image processor, each of which is electronic circuitry within a computer that carries out instructions of one or more computer programs by performing the basic arithmetic, logical, control, and input/output (I/O) operations specified by the instructions.

In embodiments, the extension 840 may include several connectors or ports, such as one or more universal serial buses (USBs), parallel ports, and/or expansion slots such as peripheral component interconnect (PCI) and PCI express (PCIe). The extension 840 is not limited to the list but may include other slots or ports that can be used for appropriate purposes. The extension 840 may be used to install hardware or add additional functionalities to a computer that may facilitate the purposes of the computer. For example, a USB port can be used for adding additional storage to the computer.

In various aspects, the display 850 may be a cathode ray tube (CRT), a liquid crystal display (LCD), or light emitting diode (LED). In various aspects, the display 850 may be a thin film transistor liquid crystal display (TFT-LCD). In various aspects, the display 850 may be an organic light emitting diode (OLED) display. In various aspects, the OLED display is a passive-matrix OLED (PMOLED) or active-matrix OLED (AMOLED) display. In various aspects, the display 850 may be a plasma display. In various aspects, the display 850 may be a video projector. In various aspects, the display may be interactive (e.g., having a touch screen or a sensor such as a camera, a 3D sensor, a LiDAR, a radar, etc.) that can detect user interactions/gestures/responses and the like. In still various aspects, the display 850 may be a hologram projector configured to project 3D objects.

A user may input and/or modify data via the input device 860 that may include a keyboard, a mouse, or any other device with which the user may input data. The display 850 may be a touch screen so that the display 850 can be used as the input device 860.

The network card 870 is used to communicate with other computing devices, wirelessly or via a wired connection. Through the network card 870, the computing device 800 may receive, modify, and/or update data from and to external devices.

Any of the herein described methods, programs, hashing algorithm, smart contracts, or codes may be converted to, or expressed in, a programming language or computer program. The terms “programming language” and “computer program,” as used herein, each include any language used to specify instructions to a computer, and include (but is not limited to) the following languages and their derivatives: Assembler, Basic, Batch files, BCPL, C, C+, C++, C #, Delphi, Fortran, Java, JavaScript, machine code, operating system command languages, Pascal, Perl, PL1, python, scripting languages, Visual Basic, meta-languages which themselves specify programs, and all first, second, third, fourth, fifth, or further generation computer languages. Also included are database and other data schemas, and any other meta-languages. No distinction is made between languages which are interpreted, compiled, or use both compiled and interpreted approaches. No distinction is made between compiled and source versions of a program. Thus, reference to a program, where the programming language could exist in more than one state (such as source, compiled, object, or linked) is a reference to any and all such states. Reference to a program may encompass the actual instructions and/or the intent of those instructions.

While several aspects of the disclosure have been shown in the drawings, it is not intended that the disclosure be limited thereto, as it is intended that the disclosure be as broad in scope as the art will allow and that the specification be read likewise. It is to be understood, therefore, that the present disclosure is not limited to the precise aspects described, and that various other changes and modifications may be affected by one skilled in the art without departing from the scope or spirit of the disclosure. Additionally, the elements and features shown and described in connection with certain aspects may be combined with the elements and features of certain other aspects without departing from the scope of the present disclosure, and that such modifications and variation are also included within the scope of the present disclosure. Therefore, the above description should not be construed as limiting, but merely as exemplifications of preferred aspects. Thus, the scope of the aspects should be determined by the appended claims and their legal equivalents, rather than by the examples given.

What is claimed:

1. A method for trading a non-fungible token (NFT) among a plurality of blockchains, the method comprising:
minting an NFT based on digital content at a first blockchain;
transferring the NFT to a second blockchain;
trading the NFT between the second blockchain and a third blockchain, which is incompatible with the first blockchain; and
recording the trade in the second blockchain.

2. The method according to claim 1, wherein the digital content is included or stored in a web server.

3. The method according to claim 2, wherein the digital content is obtained by a widget integrated into the web server.

4. The method according to claim 3, wherein the digital content is saved at a central server by the widget.

5. The method according to claim 3, wherein minting the NFT includes:
receiving selection of the digital content from an owner of the digital content.

6. The method according to claim 1, wherein minting the NFT includes:
receiving content information of the digital content; and
creating a first smart contract associated with the NFT, and
wherein the first smart contract is written to the first blockchain.

7. The method according to claim 6, wherein the content information includes a title, description, date, artist information, digital content type, a rarity type, and royalty.

8. The method according to claim 6, further comprising uploading the NFT to a digital wallet.

9. The method according to claim 6, wherein the second blockchain is an intermediary platform for trading the NFT between the first and third blockchains.

10. The method according to claim 6, wherein transferring the NFT to the second blockchain includes:
creating a second smart contract based on the first smart contract;
storing the first smart contract and the second smart contract to the second blockchain; and
transferring ownership of the NFT to the second blockchain.

11. The method according to claim 10, wherein the transfer of the NFT and the first smart contract are written in the second blockchain.

12. The method according to claim 10, wherein trading the NFT includes:
receiving an order from a user of the third blockchain;
receiving a payment via a cryptocurrency from the user based on the second smart contract; and
transferring the NFT to the third blockchain.

13. The method according to claim 12, wherein the payment via the cryptocurrency corresponds to a price included in the first smart contract.

14. A blockchain bridge platform for a non-fungible token (NFT) among a plurality of blockchains, the blockchain bridge platform comprising:
a decentralized blockchain bridge server including:
a memory configured to store instructions;
a processor operatively coupled with the memory and configured to execute the instructions to:
mint an NFT based on digital content at a first blockchain;
transfer the NFT to a second blockchain;
trade the NFT between the second blockchain and a third blockchain, which is incompatible with the first blockchain; and
record the trade in the second blockchain; and
a central server configured to store trading information including transfer of the NFT and a smart contract related to the NFT.

15. The blockchain bridge platform according to claim 14, wherein the digital content is included or stored in a web server.

16. The blockchain bridge platform according to claim 15, wherein the digital content is obtained by a widget integrated into the web server.

17. The blockchain bridge platform according to claim 16, wherein the digital content is saved at the central server.

18. The blockchain bridge platform according to claim 16, wherein, to mint the NFT, the processor executes the instructions further to:
receive selection of the digital content from an owner of the digital content.

19. The blockchain bridge platform according to claim 14, wherein, to mint the NFT, the processor executes the instructions further to:
receive content information of the digital content; and
create a first smart contract associated with the digital content, and
wherein the first smart contract is written to the first blockchain.

20. The blockchain bridge platform according to claim 19, wherein the content information includes a title, description, date, artist information, digital content type, a rarity type, and royalty.

21. The blockchain bridge platform according to claim 19, wherein the first smart contract is upload to a digital wallet.

22. The blockchain bridge platform according to claim 19, wherein the second blockchain is an intermediary platform for trading the NFT between the first and third blockchains.

23. The blockchain bridge platform according to claim 19, wherein, to transfer the NFT to the second blockchain, the processor executes the instructions further to:
create a second smart contract based on the first smart contract;
store the first smart contract and the second smart contract to the second blockchain; and
transfer the NFT to the second blockchain.

24. The blockchain bridge platform according to claim 23, wherein the transfer of the NFT and the first smart contract are written in the first blockchain.

25. The blockchain bridge platform according to claim 23, wherein, to trade the NFT, the processor executes the instructions further to:
receive an order from a user of the third blockchain;
receive a payment via a cryptocurrency from the user based on the second smart contract; and
transfer the NFT to the third blockchain.

26. The blockchain bridge platform according to claim 25, wherein the payment via the cryptocurrency corresponds to a price included in the first smart contract.

27. The blockchain bridge platform according to claim 14, wherein the central server is further configured to display the trading information including transfer of the NFT and the smart contract related to the NFT

28. A nontransitory computer-readable storage medium storing computer-executable instructions that, when executed by a computer, cause the computer to perform a method for trading a non-fungible token (NFT) among a plurality of blockchains, the method comprising:
minting an NFT based on digital content at a first blockchain;
transferring the NFT to a second blockchain;
trading the NFT between the second blockchain and a third blockchain, which is incompatible with the first blockchain; and
recording the trade in the second blockchain.
